(19) United States
(12) Patent Application Publication
(10) Pub. No.: US 2026/0179377 A1
(43) Pub. Date: Jun. 25, 2026

(54) METHOD AND APPARATUS FOR EVALUATING QUALITY OF URBAN NIGHTTIME LIGHTING ENVIRONMENT

(71) Applicant: Tongji University, Shanghai (CN)

(72) Inventors: Yi LIN, Shanghai (CN); Xianxian ZENG, Shanghai (CN); Shenfei CHEN, Shanghai (CN); Bing ZHANG, Shanghai (CN)

(21) Appl. No.: 19/218,303

(22) Filed: May 25, 2025

(30) Foreign Application Priority Data
Dec. 20, 2024 (CN) 202411884993.3

(51) Int. Cl. G06V 20/10

(52) U.S. Cl. CPC G06V 20/176

(57) ABSTRACT

A method and apparatus for evaluating quality of an urban nighttime lighting environment are provided, and relate to the technical field of evaluating quality of urban night spaces. The apparatus includes a data acquisition sub-apparatus and a terminal. The data acquisition sub-apparatus is configured to acquire multimodal data; the multimodal data includes human physiological data, nighttime environment data, and body position data. The terminal is configured to: generate a nighttime lighting environment-emotional quality evaluation map according to the multimodal data, determine types of regions on the nighttime lighting environment-emotion quality evaluation map according to emotional state values, and evaluate the quality of the urban nighttime lighting environment for different types of regions. Accurate and proper quantified data can be provided, so that evaluating quality of the urban nighttime lighting environment is more objective and accurate.

### CROSS-REFERENCE TO RELATED APPLICATION

This patent application claims the benefit and priority of Chinese Patent Application No. 202411884993.3 filed with the China National Intellectual Property Administration on Dec. 20, 2024, the disclosure of which is incorporated by reference herein in its entirety as part of the present application.

### TECHNICAL FIELD

The present disclosure relates to the technical field of evaluation of quality of urban nightscape, and in particular, to a method and apparatus for evaluating quality of urban nighttime lighting environment.

### BACKGROUND

The evaluation of quality of urban nightscape has always been a core research issue in fields such as landscape studies, urban planning, and environmental psychology. Traditional evaluation methods mostly use subjective evaluation methods, such as questionnaire surveys, interviews, and focus groups, which rely on self-reports of participants. However, subjective feelings are often vague, and it is difficult to accurately describe the subjective feelings. In addition, under the impact of individual differences and situational factors, data consistency and repeatability are poor, making it difficult for quantitative analysis and comparison. Therefore, these evaluation methods have significant subjectivity and instability, so that it is difficult to provide accurate and proper quantitative data. This results in obvious limitations when these evaluation methods are applied on a large scale and cannot effectively meet current research requirement for high-precision and objective evaluation methods.

### SUMMARY

The present disclosure aims to provide an apparatus for evaluating the quality of urban nighttime lighting environments, which can provide accurate and proper quantified data, so that the evaluation of the quality of the urban nighttime lighting environment is more objective and accurate.

To achieve the above objective, the present disclosure provides the following technical solution:

In a first aspect, the present disclosure provides an apparatus for evaluating the quality of an urban nighttime lighting environment, including a data acquisition sub-apparatus and a terminal.

The data collection sub-apparatus is in communication connection to the terminal.

The data acquisition sub-apparatus is configured to acquire multimodal data, wherein the multimodal data includes human physiological data, nighttime environment data, and body position data.

The terminal is configured to: generate a nighttime lighting environment-emotion quality evaluation map according to the multimodal data, determine types of regions on the nighttime lighting environment-emotion quality evaluation map according to emotional state values, and evaluate the quality of the urban nighttime lighting environment for different types of regions, wherein the emotional state values are variable values calculated according to the multimodal data; and the types of the regions include abnormal regions and non-abnormal regions.

In a second aspect, the present disclosure provides a method for evaluating quality of an urban nighttime lighting environment, including:

acquiring multimodal data, where the multimodal data includes human physiological data, nighttime environment data, and body position data;

generating a nighttime lighting environment-emotion quality evaluation map according to the multimodal data;

determining types of regions on the nighttime lighting environment-emotion quality evaluation map according to emotional state values, wherein the emotional state values are variable values calculated according to the multimodal data; and the types of the regions include abnormal regions and non-abnormal regions; and

evaluating the quality of the urban nighttime lighting environment for different types of regions.

The present disclosure provides a method and apparatus for evaluating quality of an urban nighttime lighting environment. The apparatus includes a data acquisition sub-apparatus and a terminal. The data acquisition sub-apparatus is configured to acquire multimodal data; the multimodal data includes human physiological data, nighttime environment data, and body position data. The terminal is configured to: generate a nighttime lighting environment-emotion quality evaluation map according to the multimodal data, determine types of regions on the nighttime lighting environment-emotion quality evaluation map according to emotional state values, and evaluate the quality of the urban nighttime lighting environment for different types of regions. By acquiring and processing the multimodal data, individual emotional states and light environment parameters can be quantified in real time, thereby more objectively and accurately evaluating the impact of the urban nighttime lighting environment on the individual emotional states and providing a basis for the optimal design of the urban light environment.

### BRIEF DESCRIPTION OF THE DRAWINGS

To describe the technical solutions in the embodiments of the present disclosure or in the prior art more clearly, the following will briefly introduce the accompanying drawings needing to be used in the embodiments. Apparently, the accompanying drawings in the following description show merely some embodiments of the present disclosure, and a person of ordinary skill in the art may still derive other drawings from the accompanying drawings without creative efforts.

FIG. 1 is a schematic structural diagram of an apparatus for evaluating quality of an urban nighttime lighting environment in Embodiment 1 of the present disclosure;

FIG. 2 is a schematic structural diagram of a data acquisition sub-apparatus in Embodiment 1 of the present disclosure;

FIG. 3 is a partially structural diagram of a data acquisition sub-apparatus in Embodiment 1 of the present disclosure; and

FIG. 4 is a flowchart of a method for evaluating quality of an urban nighttime lighting environment in Embodiment 2 of the present disclosure.

Numerals in the drawings:
1: first camera; 2: electrodermal activity (EDA) subunit; 3: photoplethysmography (PPG) subunit; 4: noise sensor; 5: global positioning system (GPS) subunit; 6: photometric data measurement sensor; 7: second camera; 8: temperature sensor; 9: humidity sensor; 10: wind speed sensor; 11: data preprocessing module; 12: data storage module; 13: communication transmission module; and 14: power supply module.

### DETAILED DESCRIPTION OF THE EMBODIMENTS

The technical solutions in embodiments of the present disclosure are clearly and completely described in the following with reference to the accompanying drawings in the embodiments of the present disclosure. Apparently, the described embodiments are merely some rather than all the embodiments of the present disclosure. All other embodiments obtained by a person of ordinary skill in the art based on the embodiments of the present disclosure without making creative efforts shall fall within the protection scope of the present disclosure.

To make the above objectives, features, and advantages of the present disclosure more comprehensible, the present disclosure will be further described in detail below in combination with the accompanying drawings and specific implementations.

### Embodiment 1

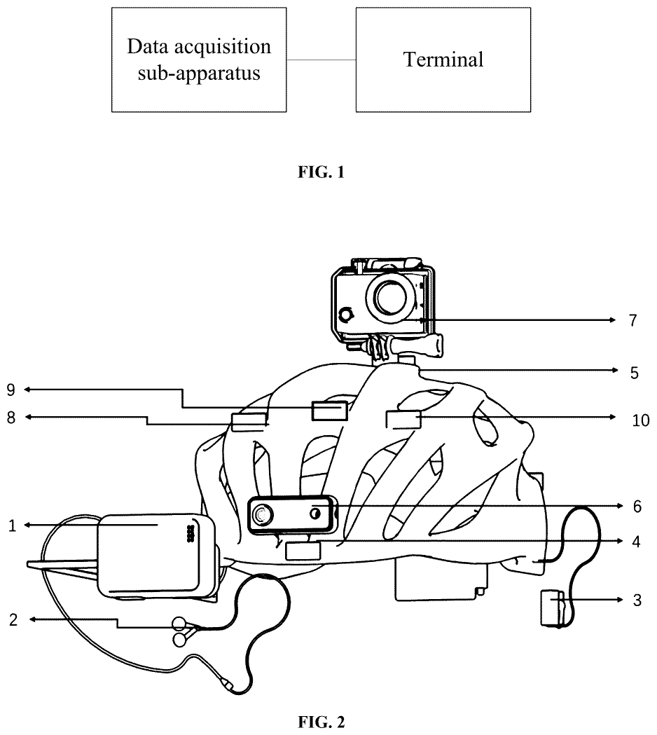

As shown in FIG. 1, this embodiment provides an apparatus for evaluating quality of an urban nighttime lighting environment, including a data acquisition sub-apparatus and a terminal.

The data collection sub-apparatus is in communication connection to the terminal.

The data acquisition sub-apparatus is configured to acquire multimodal data, wherein the multimodal data includes human physiological data, nighttime environment data, and body position data; the human physiological data includes facial expression images, skin conductance data, and HRV data; the nighttime environment data includes photometric data, urban image data, environmental temperature, environmental humidity, a wind speed, and noise; and the photometric data includes spectral data and strobing.

The terminal is configured to: generate a nighttime lighting environment-emotion quality evaluation map according to the multimodal data, determine types of regions on the nighttime lighting environment-emotion quality evaluation map according to emotional state values, and evaluate the quality of the urban nighttime lighting environment for different types of regions. The emotional state values are variable values calculated according to the multimodal data; and the types of the regions include abnormal regions and non-abnormal regions.

The terminal further includes a human physiological data processing module, a data integration module, an emotional state value processing module, a nighttime lighting environment-emotion quality evaluation map generation module, a region type classification module and an evaluation module.

The human physiological data processing module is configured to: extract feature values according to the human physiological data and calculate the emotional state values by using an affective computing model (Picard, 2000), using the feature values as input. Each emotional state value comprises both valence and arousal dimensions.

The data integration module is configured to establish an association relationship among the emotional state value, the nighttime environment data, and the body position data by using a time stamp and a spatial coordinate as indexes.

The emotional state value processing module is configured to: determine, according to concomitant variables, whether the emotional state values are abnormal, remove abnormal emotional state values from the emotional state values, and interpolate remaining emotional state values after removal by using an interpolation algorithm, to obtain processed emotional state values, where an environmental temperature, an environmental humidity, a wind speed, and noise in the nighttime environment data are used as the concomitant variables.

The nighttime lighting environment-emotion quality evaluation map generation module is configured to: generate the nighttime lighting environment-emotion quality evaluation map according to the processed emotional state values, the body position data, and photometric data and urban image data in the nighttime environment data.

The region type classification module is configured to: perform spatial statistical analysis on the processed emotional state values on the nighttime lighting environment-emotion quality evaluation map and determine the types of the regions on the nighttime lighting environment-emotion quality evaluation map according to an analysis result.

The evaluation module is configured to evaluate the quality of the urban nighttime lighting environment for different types of regions.

Light stimulation directly or indirectly affects human emotions through both a visual channel and a non-visual channel. The visual channel mainly involves stimulation to retinal cone cells and rod cells from light, which affects cognitive activities such as visual function and a mental workload of a person. The non-visual channel transmits information to the suprachiasmatic nucleus (SCN) in the brain through intrinsically photosensitive retinal ganglion cells (ipRGCs), which affects the circadian rhythm of a person and subsequently affects the emotional state of the person. Research has shown that specific lighting conditions (such as blue light stimulation with a cold color temperature and high illumination) can significantly enhance the attention and alertness of an individual or induce some physiological responses (such as a rapid heart rate and an enhanced electrodermal activity).

This embodiment can quantitatively analyze emotional state changes of an individual in different scenarios by detecting, in real time, multimodal physiological signals (including but not limited to heart rate variability (HRV) data from the PPG subunit, skin conductance (SC) data from the EDA subunit, etc.) of a pedestrian in an urban nighttime outdoor environment in conjunction with affective computing. This method not only helps to understand the impact of the lighting environment on human psychological and physiological states but also provides a quantifiable basis for optimizing the design of a nighttime lighting environment.

Through research, it has been found that an existing urban street environment data acquisition apparatus mainly relies on a built-in sensor and a detection technology, which can record a physiological state of a wearer and environmental parameters. However, most apparatuses are only designed for daytime street data acquisition and have significant shortcomings when used at night, manifested in the following aspects:

\textcircled{1} Limitation of single-mode information acquisition: Most apparatuses only acquire single physiological indicators (such as a heart rate or skin conductance), and ignore integration of multimodal information. This single data acquisition mode cannot fully reflect a multidimensional perceptual response in a complex environment.

\textcircled{2} Insufficient nighttime data acquisition function: The existing apparatuses are mainly designed for daytime environments and lack an acquisition function for nighttime lighting environments, such as illumination, color temperature, and low-light high-definition video data. The accuracy and completeness of data acquisition in low-light environments are insufficient.

\textcircled{3} Poor synchronization and interference resistance of multimodal data: The multimodal data is susceptible to external interference during acquisition, causing asynchronous data, thereby affecting the analysis accuracy. For example, there are common problems such as a signal transmission delay and sensor interference.

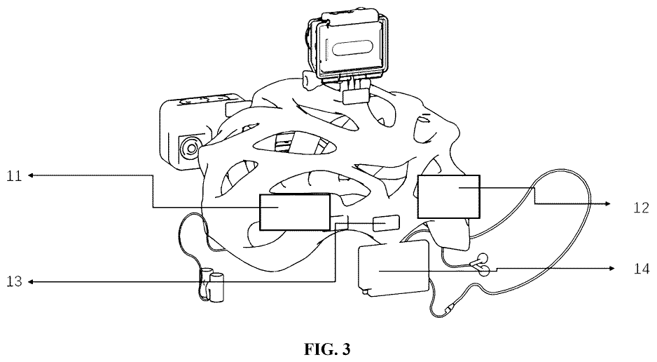

In view of this, this embodiment further designs a portable acquisition apparatus (i.e. the data acquisition sub-apparatus) that can integrate multimodal physiological data with environmental data. As shown in FIG. 2 and FIG. 3, the data acquisition sub-apparatus may be a wearable helmet. The data acquisition sub-apparatus includes: a housing, a data acquisition module, a data preprocessing module 11, and a communication transmission module 13. The data acquisition module, the data preprocessing module 11, and the communication transmission module 13 are all located on the housing.

The data preprocessing module 11 is connected to the data acquisition module and the communication transmission module 13.

The data acquisition module is configured to acquire the multimodal data. The multimodal data includes human physiological data, nighttime environment data, and body position data.

The data acquisition module further includes: a human physiological data acquisition unit, a nighttime environment data acquisition unit, and a position information acquisition unit.

The human physiological data acquisition unit, the nighttime environment data acquisition unit, and the position information acquisition unit are all connected to the data preprocessing module 11.

The human physiological data acquisition unit is configured to acquire the human physiological data, wherein the human physiological data includes facial expression images, skin conductance data, and HRV data.

The human physiological data acquisition unit is composed of a plurality of sensor modules for measuring human vital signs, including: a first camera 1 (for capturing facial expressions), an electrodermal activity (EDA) subunit 2 (for acquiring skin conductance data), and a photoplethysmography (PPG) subunit 3 (for acquiring HRV data). HRV metrics are derived from PPG signals. These sensor modules are responsible for acquiring the human physiological data, to provide basic data for analyzing the quality of the urban nighttime lighting environment.

Specifically, a facial expression capture subunit (i.e. the first camera 1) is mounted at a position that is 15 cm in front of a face through a holder, which optimizes a viewing angle and distance for capturing facial expression and ensures acquisition of high-precision facial image data. It supports near-infrared and normal shooting modes, with a resolution of 1080 p, a frame rate of 30 fps, and a viewing angle of 90 degrees, to capture clear facial expression images. The facial expression capture subunit has an automatic light compensation function, supports shooting in a nighttime low-light environment, and is suitable for precisely capturing in the low-light environment.

The electrodermal activity subunit 2 is mounted on a right side of the helmet. A sensor is configured to acquire skin conductance data upon being in contact with a finger pulp, with an accuracy of ±0.1 μs and a sampling frequency of 128 Hz.

The photoplethysmography subunit 3 is arranged on a left side of a forehead of the helmet. A sensor is in contact with an earlobe upon wearing the helmet, to acquire HRV data at the earlobe in real time, with a sampling frequency of 1024 Hz.

The nighttime environment data acquisition unit is configured to acquire the nighttime environment data. The nighttime environmental data includes photometric data (spectral data and strobing), urban image data, an environmental temperature, an environmental humidity, a wind speed, and noise.

The nighttime environment data acquisition unit includes: a photometric data measurement sensor 6 (for capturing the spectral data and strobing of human eyes or near the human eyes), a second camera 7 (for recording environmental images, i.e. the urban image data), a temperature sensor 8, a humidity sensor 9, a wind speed sensor 10, and a noise sensor 4. These sensors can collaborate with each other to synchronously measure various environmental parameters, to provide complete environmental background information for data analysis.

Specifically, the photometric data measurement sensor 6 is mounted in the middle of the forehead of the helmet to capture the photometric data of the human eyes/near the human eyes, and can measure light with a wavelength ranging from 380 to 780 nm. The photometric data measurement sensor 6 has a spectral resolution of 0.1 nm, illumination of 0.1 1× to 20000 1×, and a color temperature of 1000 K to 100000 K. A size of the sensor is 35×35 mm.

The second camera 7 is mounted at the top of the head, with a wide-angle view of 120 degrees and a size of 35×35 mm. It supports high-definition images and low-light shooting, captures the urban image data in the view of a pedestrian/near the pedestrian, is suitable for shooting in a low-light environment.

The temperature/humidity sensor 9 is mounted at a front portion of the helmet, with an environmental temperature measurement range of −40° C. to 85° C., a humidity range of 0-100% RH, and a size of 10×20 mm.

The wind speed sensor 10 is mounted at the front portion of the helmet, with a measurement range of 0.1 m/s to 30 m/s and an accuracy of ±0.1 m/s.

The noise sensor 4 is mounted at the front portion of the helmet, with a measurement range of 30 dBA to 130 dBA and an accuracy of ±1.5 dB.

The position information acquisition unit is configured to acquire the body position data.

The position information acquisition unit is mounted at the top of the helmet and is composed of a GPS subunit 5, with an accuracy ranging from 0.5 meters to 2 meters. It supports high-frequency data update (1 Hz) and is configured to acquire real-time position information and movement trajectories of a person. In addition, the position information acquisition unit is further integrated with an inertial navigation system to improve the accuracy of outdoor positioning, especially in a case of unstable signals. Through efficient connection with a power supply system, this unit ensures a continuous positioning accuracy under various environmental conditions and operates in conjunction with other systems, to provide accurate geographic position references for data analysis.

The data preprocessing module 11 is configured to preprocess the multimodal data.

The data preprocessing module 11 further includes an abnormality detection and correction unit and a data synchronization and fusion unit.

The abnormality detection and correction unit is connected to the data acquisition module and the data synchronization and fusion unit.

The data synchronization and fusion unit is connected to the communication transmission module 13.

The abnormality detection and correction unit is configured to: identify an abnormal situation in the multimodal data, and perform abnormality correction and alarming, where the abnormal situation includes signal loss, data noise, and a device failure. For example, abnormality values in data are automatically identified through an abnormality identification model (such as signal loss detection and noise screening), and data is corrected by using an interpolation algorithm or a machine-learning-based correction method, to ensure the quality of the data.

The data synchronization and fusion unit is configured to process the corrected multimodal data by using a time synchronization algorithm, to obtain time-synchronized multimodal data. For example, based on a timestamp alignment algorithm, the human physiological data (such as skin conductance and HRV data) and the nighttime environment data are synchronously processed, to ensure the consistency of the data in the time dimension.

By using the time synchronization and data fusion technology, millisecond-level synchronization and denoising of the multimodal data are achieved to ensure the accuracy and consistency of the data.

The communication transmission module 13 is configured to transmit the preprocessed multimodal data to the terminal.

A user can perform data visualization and interaction operations to display a data state and an analysis result by the terminal (such as a computer, a tablet computer, or a mobile phone). The terminal further includes a human-oriented physiological feedback processing module and an urban nighttime spatial data construction module. The data output by the two modules provides a support for an optimal design of the urban nighttime lighting environment through coupled analysis.

The communication transmission module 13 is configured to transmit the preprocessed multimodal data to the terminal (such as the computer, the tablet computer, or a smart phone), and supports various communication protocols such as Wi-Fi 6, Bluetooth 5.0, 4G/5G cellular network, and Zigbee, to ensure data transmission speeds and security in different network environments. During data transmission, the module further supports functions such as data compression and encryption, to ensure integrity and privacy of the data.

The data acquisition sub-apparatus provided in this embodiment further includes a power supply module 14 and a data storage module 12.

The power supply module 14 stores electric energy, converts the electric energy into working power for various modules, and includes various transformation and ballast units for supplying stable power. The power supply module further includes an energy efficiency management unit, which is configured to: automatically adjust a power output according to loads of various modules, control various modules to enter a low-power consumption mode when the loads are less than a threshold, monitor a battery level in real time, and remind, in case of a low battery or a battery needs to be replaced, a user to replace or charge the battery.

The data storage module 12 supports local and cloud data storage, adopts a distributed database architecture, and provides data backup and recovery functions, to ensure the security and integrity of the data.

Specifically, the acquired data is first stored in a local storage device (such as a secure digital (SD) card) for quick access and offline use. Meanwhile, the data is uploaded to a cloud platform by using communication transmission module 13 (such as Wi-Fi or a cellular network), to achieve remote backup and access. The data storage module 12 further has an automatic synchronization function and uploads local data to a cloud according to a set rule when network conditions permit.

The apparatus for evaluating the quality of the urban nighttime lighting environment of this embodiment has the following advantages:

### 1. Portable Optimal Design

This embodiment uses a modular design and provides a miniaturized portable acquisition apparatus. The device has a weight not greater than 1500 grams, is small in volume, has a low-power consumption characteristic, is easy to carry, and is suitable for outdoor real-time monitoring and mobile acquisition in the urban nighttime lighting environment.

### 2. Integrated Apparatus for Multimodal Data Acquisition

A helmet-style multimodal data acquisition apparatus is designed, which can simultaneously acquire the human physiological data (such as facial expression images, skin conductance, and HRV), the body position data (obtained through a GPS and an inertial navigation system), and the nighttime environment data (such as spectral data, wide-angle camera images, a temperature, a humidity, a wind speed, and noise). By optimizing the spatial layout of various modules, this embodiment solves the problem of poor synchronization caused by dispersion of multiple devices and achieves high-accuracy and high-stability data acquisition. The data is analyzed in real time through a processing module of the apparatus, thus forming a closed loop of data acquisition and feedback.

### 3. Real-Time Synchronization and Abnormality Detection of Multimodal Data

Through the time synchronization algorithm and the data fusion technology, this embodiment achieves millisecond-level synchronization on the human physiological data, the body position data, and the nighttime environment data. By combining the machine-learning-based abnormality detection model, data abnormalities (such as signal loss, interference, or a device failure) can be identified in real time and corrected. Meanwhile, a wireless data transmission function is supported, and data can be transmitted in real time to a remote terminal (such as a computer and a mobile phone), thus ensuring the reliability and integrity of data acquisition.

### 4. Interdisciplinary Data Analysis and Evaluation Model

This embodiment achieves the evaluation of the quality of the nighttime lighting environment by integrating various algorithms such as light environment science, psychology, physiology, and data science in conjunction with multimodal physiological signal affective computing algorithm thereby improving the accuracy and efficiency of quality analysis. This embodiment can provide suggestions for the optimal design of the light environment, thus forming a feedback closed loop centered on user experience. The integration of multiple disciplines has significantly improved the accuracy and scientificity of evaluation of a light environment, which solves the limitation of a traditional single-discipline method.

### Embodiment 2

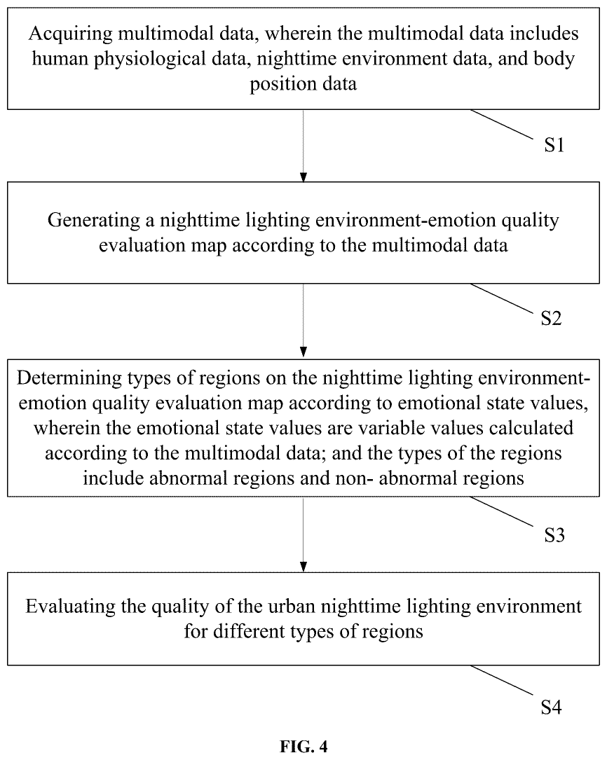

As shown in FIG. 4, this embodiment provides a method for evaluating quality of an urban nighttime lighting environment, including:
S1: acquiring multimodal data, wherein the multimodal data includes human physiological data, nighttime environment data, and body position data;
S2: generating a nighttime lighting environment-emotion quality evaluation map according to the multimodal data;
S3: determining types of regions on the nighttime lighting environment-emotion quality evaluation map according to emotional state values, wherein the emotional state values are variable values calculated according to the multimodal data; and the types of the regions include abnormal regions and non-abnormal regions; and
S4: evaluating the quality of the urban nighttime lighting environment for different types of regions.

S3 specifically includes:
S31: extracting feature values according to the human physiological data and calculating the emotional state values by using an affective computing model with the feature values as an input;
S32: determining, according to concomitant variables, whether the emotional state values are abnormal, removing abnormal emotional state values from the emotional state values, and interpolating remaining emotional state values after removal by using an interpolation algorithm, to obtain processed emotional state values, wherein an environmental temperature, an environmental humidity, a wind speed, and noise in the nighttime environment data are used as the concomitant variables;
S33: generating the nighttime lighting environment-emotion quality evaluation map according to the processed emotional state values, the body position data, and photometric data and urban image data in the nighttime environment data; and
S34: performing spatial statistical analysis on the processed emotional state values on the nighttime lighting environment-emotion quality evaluation map, and determining the types of the regions on the nighttime lighting environment-emotion quality evaluation map according to an analysis result.

To make a person skilled in the art have a clearer understanding of the specific process of the above method for evaluating the quality of the urban nighttime lighting environment in this embodiment, the following will provide a detailed explanation.

### (1) Emotional State Value Measurement

Light stimulation act on retinas through a visual channel and a non-visual channel, which directly or indirectly affects the emotional perception of a person. Urban nightscape lighting, which reshapes a landscape of an outdoor public space in a city with artificial light at night, also has an impact on the emotion of a person. There is a correlation between the emotion of the person and various factors such as brightness, illumination, a color temperature, a light color, dynamic and flickering changes, and spatial distribution of brightness in the urban light environment. Good lighting quality, such as an appropriate brightness and a suitable color temperature, has a positive effect on the emotion of the person, but landscape lighting that is too dark, too bright, too colorful, or too flashing may cause extreme discomfort to people. Furthermore, this uncomfortable emotional response will be reflected in various physiological indicators of a human body, such as skin conductance, HRV, breathing, and facial expressions. Therefore, a current emotional state of a human body can be obtained by measuring various physiological indicators and using an affective computing model. An urban night space can be further evaluated in real time in conjunction with other data of the light environment.

Emotion is a complex process that involves multiple aspects such as cognition, sensation, motivation, physical response, and movement. This embodiment uses a two-dimensional affective model to process the human physiological data. This model simplifies and quantifies emotional responses in two dimensions: emotional valence and emotional arousal. The emotional valence reflects a preference degree of an individual for stimulation, i.e., ranging from like to dislike. The emotional arousal describes the intensity of emotional excitement, from low excitement to high excitement.

The heart rate variability can reflect the emotional valence and emotional arousal of an individual.

The skin conductance response can reflect an arousal response of an individual to an environmental stimulation.

Facial expression video data can be converted into corresponding values in the two-dimensional affective model by using existing software.

### Feature Value Extraction

Skin conductance data: A skin conductance level (SCL) signal is extracted, the skin conductance signal is normalized by using a Z-score normalization formula, and individual baseline differences are eliminated.

HRV data: Time-domain features (such as a standard deviation of normal-to-normal intervals (SDNN) and a Root Mean Square of Successive Difference (RMSSD)) and frequency-domain features (such as a low-frequency/high-frequency (LF/HF) power ratio) of the heart rate variability (HRV) are calculated.

Facial expression images: Expression classification labels (such as pleasure and disgust) are extracted through an image analysis technology, and expression changes are quantified by using the two-dimensional affective model in conjunction with facial muscle movement features.

The above extracted feature values are integrated into a high-dimensional emotional feature vector through a feature fusion algorithm, and the vector is input to the two-dimensional affective model through a deep learning algorithm, to output the two dimensions: the emotional valence and the emotional arousal.

Finally, a multimodal affective computing result is aligned with timestamp coordinates to form the emotional state values with temporal and spatial consistency.

### (2) Construction of a Nighttime Environmental Dataset

The photometric data, the urban image data, the environmental temperature, the environmental humidity, the wind speed, and the noise, as well as the GPS position information in the body position data are acquired and integrated to generate a multidimensional nighttime environmental dataset for analysis. Specifically, the acquired photometric data, urban image data, environmental temperature, environmental humidity, wind speed, noise, and other nighttime environmental parameters are integrated by using the timestamp and the spatial coordinate as the indexes, and are stored in a structured database. A geographic information system (GIS) tool is used to spatially process the integrated data, to generate geographic mapping information and form a standardized nighttime environmental dataset.

### (3) Generation of a Nighttime Lighting Environment-Emotion Quality Evaluation Map

An urban light environment has a complex impact mechanism on human vision-emotion, which can be summarized into two aspects: essential factors of illumination, including light brightness, spectrum, spatial distribution, and moment/duration of action and having an effect on human vision, physiology, and psychology in the form of radiation energy of light; and an urban nighttime landscape that is created by using artificial light as a technical means to reshape complex urban landscape elements. This nighttime landscape is projected into a human brain through a visual system and processed by a nervous system for emotional processing in the brain, thus creating an emotional experience for people. This embodiment acquires nighttime environment data, physiological data and body position data of a subject, and processes the data through an algorithm to generate a model for evaluating a relationship between the nighttime lighting environment and emotions. From the perspective of emotions of a user, to evaluate the quality of the urban light environment, basic content is as follows.

Analysis of a relationship between the nighttime lighting environment and multimodal affective computing is as follows. Based on the timestamp, the multimodal affective computing result is coupled with the nighttime lighting environment dataset at the spatial position to construct a spatial mapping model, thus generating the nighttime lighting environment-emotion quality evaluation map. Distributions of emotional valences and emotional arousals at different positions are labeled. Regions with low emotional valence and high emotional arousal are preferentially identified, thus inferring potential problems of the nighttime landscape.

Abnormity of the concomitant variables is detected. Since significant fluctuations of the environmental temperature, the environmental humidity, the wind speed, and the noise may have potential impact on a multi-source emotional value, the environmental temperature, the environmental humidity, the wind speed, and the noise are included as concomitant variables in the spatial mapping model, to quantify their potential impact effects. Firstly, a change point detection algorithm is used to identify the time points of abnormal fluctuations in covariates. Data of abnormally increased part of the concomitant variables (temperature, humidity, wind speed, and noise) is selected to be removed according to an actual requirement. Finally, an interpolation algorithm is used to perform spatial continuity processing on the data, to generate a distribution map of the emotional state values in a geographic space.

### (4) Classification and Spatial Statistical Analysis

Spatial statistical analysis is performed on the emotional state values in the nighttime lighting environment-emotion quality evaluation map to identify and locate key regions. Spatial hot and cold spot analysis is performed on the arousal and valence dimensions of the emotional state values, and a spatial statistical method (such as Getis-Ord Gi*) is used to label emotional features of different regions. Identification of high arousal and low valence regions is focused on, and these regions are defined as “abnormal regions” as key targets in the analysis. These abnormal regions may characterize potential night space light environment quality issues or high-incidence regions with poor emotional experiences.

### (5) Evaluation and Optimization Feedback

For the key regions, deep analysis is performed in conjunction with the photometric data and the urban image data to further evaluate problems and make decisions, thus forming a closed-loop feedback mechanism.

The method for evaluating the quality of the urban nighttime lighting environment provided in this embodiment can quantify individual emotional states and light environment parameters in real time by acquiring and processing the multimodal data, and more objectively and accurately evaluate the impact of the urban nighttime lighting environment on the individual emotional states, to provide a basis for the optimal design of the urban light environment.

All the technical features of the above embodiments can be combined randomly. For the sake of brevity, all possible combinations of all the technical features in the above embodiments are not described. However, these technical features shall all be considered to fall within the scope of this specification as long as there is no contradiction in their combinations.

Specific examples are used herein to illustrate the principles and implementations of the present disclosure. The descriptions of the above embodiments are only used to help understand the method of the present disclosure and its core idea; and at the same time, those of ordinary skill in the art will make changes to all the specific implementations and application scopes according to the idea of the present disclosure. In conclusion, the content of this specification shall not be understood as a limitation on the present disclosure.

What is claimed is:

1. An apparatus for evaluating quality of an urban nighttime lighting environment, comprising:
a data acquisition sub-apparatus and a terminal,
wherein the data acquisition sub-apparatus is in communication connection to the terminal;
the data acquisition sub-apparatus is configured to acquire multimodal data, wherein the multimodal data comprises human physiological data, nighttime environment data, and body position data;
the terminal is configured to: generate a nighttime lighting environment-emotion quality evaluation map according to the multimodal data, determine types of regions on the nighttime lighting environment-emotion quality evaluation map according to emotional state values, and evaluate the quality of the urban nighttime lighting environment for different types of regions, wherein the emotional state values are variable values calculated according to the multimodal data; and the types of the regions comprise abnormal regions and non-abnormal regions.

2. The apparatus for evaluating the quality of the urban nighttime lighting environment according to claim 1, wherein the terminal comprises:
a human physiological data processing module, configured to: extract feature values according to the human physiological data, and calculate the emotional state values by using an affective computing model with the feature values as an input;
an emotional state value processing module, configured to: determine, according to concomitant variables, whether the emotional state values are abnormal, remove abnormal emotional state values from the emotional state values, and interpolate remaining emotional state values after removal by using an interpolation algorithm to obtain processed emotional state values, wherein an environmental temperature, an environmental humidity, a wind speed, and noise in the nighttime environment data are used as the concomitant variables;
a nighttime lighting environment-emotion quality evaluation map generation module, configured to: generate the nighttime lighting environment-emotion quality evaluation map according to the processed emotional state values, the body position data, and photometric data and urban image data in the nighttime environment data;
a region type classification module, configured to: perform spatial statistical analysis on the processed emotional state values on the nighttime lighting environment-emotion quality evaluation map, and determine the types of the regions on the nighttime lighting environment-emotion quality evaluation map according to an analysis result; and
an evaluation module, configured to evaluate the quality of the urban nighttime lighting environment for different types of regions.

3. The apparatus for evaluating the quality of the urban nighttime lighting environment according to claim 1, wherein the data acquisition sub-apparatus is a wearable helmet, and the data acquisition sub-apparatus comprises:
a housing, a data acquisition module, a data preprocessing module, and a communication transmission module;
the data acquisition module, the data preprocessing module, and the communication transmission module are all located on the housing;
the data preprocessing module is connected to the data acquisition module and the communication transmission module;
the data acquisition module is configured to acquire the multimodal data;
the data preprocessing module is configured to preprocess the multimodal data; and
the communication transmission module is configured to transmit the preprocessed multimodal data to the terminal.

4. The apparatus for evaluating the quality of the urban nighttime lighting environment according to claim 3, wherein the data acquisition module further comprises: a human physiological data acquisition unit, a nighttime environment data acquisition unit, and a position information acquisition unit;
the human physiological data acquisition unit, the nighttime environment data acquisition unit, and the position information acquisition unit are all connected to the data preprocessing module;
the human physiological data acquisition unit is configured to acquire the human physiological data, wherein the human physiological data comprises facial expression images, skin conductance data, and HRV data;
the nighttime environment data acquisition unit is configured to acquire the nighttime environment data, wherein the nighttime environment data comprises photometric data, urban image data, an environmental temperature, an environmental humidity, a wind speed, and noise, and the photometric data comprises spectral data and strobing; and
the position information acquisition unit is configured to acquire the body position data.

5. The apparatus for evaluating the quality of the urban nighttime lighting environment according to claim 3, wherein the data preprocessing module further comprises an abnormality detection and correction unit and a data synchronization and fusion unit;
the abnormality detection and correction unit is connected to the data acquisition module and the data synchronization and fusion unit;
the data synchronization and fusion unit is connected to the communication transmission module;
the abnormality detection and correction unit is configured to: identify an abnormal situation in the multimodal data, and perform abnormality correction and alarming, wherein the abnormal situation comprises signal loss, data noise, and a device failure; and
the data synchronization and fusion unit is configured to process corrected multimodal data by using a time synchronization algorithm, to obtain time-synchronized multimodal data, wherein the time-synchronized multimodal data is used as the preprocessed multimodal data.

6. The apparatus for evaluating the quality of the urban nighttime lighting environment according to claim 3, wherein the data acquisition sub-apparatus further comprises a data storage module;
the data storage module is connected to the data acquisition module and the communication transmission module;
the data storage module is configured to store the preprocessed multimodal data locally and/or in a cloud; and the data storage module uses a distributed database architecture.

7. The apparatus for evaluating the quality of the urban nighttime lighting environment according to claim 3, wherein the data acquisition sub-apparatus further comprises a power supply module;
the power supply module is connected to the data acquisition module, the data preprocessing module, and the communication transmission module;
the power supply module is configured to provide power;
the power supply module further comprises an energy efficiency management unit; and
the energy efficiency management unit is configured to: automatically adjust a power output according to a load of each module, control each module to enter a low-power consumption mode when the load is less than a threshold, monitor a battery level in real time, and remind, in case of a low battery or that a battery needs to be replaced, a user to replace or charge the battery.

8. The apparatus for evaluating the quality of the urban nighttime lighting environment according to claim 4, wherein the nighttime environment data acquisition unit comprises a photometric data measurement sensor, a camera, a temperature sensor, a humidity sensor, a wind speed sensor, and a noise sensor.

9. A method for evaluating quality of an urban nighttime lighting environment, comprising:
acquiring multimodal data comprising human physiological data, nighttime environment data, and body position data;
generating a nighttime lighting environment-emotion quality evaluation map according to the multimodal data;
determining types of regions on the nighttime lighting environment-emotion quality evaluation map according to emotional state values, wherein the emotional state values are variable values calculated according to the multimodal data; and the types of the regions comprise abnormal regions and non-abnormal regions; and
evaluating the quality of the urban nighttime lighting environment for different types of regions.

10. The method for evaluating the quality of the urban nighttime lighting environment according to claim 9, wherein the determining types of regions on the nighttime lighting environment-emotion quality evaluation map according to emotional state values comprises:
extracting feature values according to the human physiological data, and calculating the emotional state values by using an affective computing model with the feature values as an input;
determining, according to concomitant variables, whether the emotional state values are abnormal, removing abnormal emotional state values from the emotional state values, and interpolating remaining emotional state values after removal by using an interpolation algorithm, to obtain processed emotional state values, wherein an environmental temperature, an environmental humidity, a wind speed, and noise in the nighttime environment data are used as the concomitant variables;
generating the nighttime lighting environment-emotion quality evaluation map according to the processed emotional state values, the body position data, and photometric data and urban image data in the nighttime environment data; and
performing spatial statistical analysis on the processed emotional state values on the nighttime lighting environment-emotion quality evaluation map, and determining the types of the regions on the nighttime lighting environment-emotion quality evaluation map according to an analysis result.
